(19) United States
(12) Patent Application Publication
(10) Pub. No.: US 2026/0340932 A1
(43) Pub. Date: Oct. 29, 2026

(54) GENERATIVE VIEW SYNTHESIS WITH DIFFUSION MODEL

(71) Applicant: Stability AI Ltd, London (GB)

(72) Inventors: Jensen Zhou, Oxford (GB); Hang Gao, Berkeley, CA (US); Vikram Voleti, Kitchener (CA); Aaryaman Vasishta, London (GB); Chun-Han Yao, Sunnyvale, CA (US); Mark Boss, Tübingen (DE); Varun Jampani, Rockland, MD (US)

(73) Assignee: Stability AI Ltd, London (GB)

(21) Appl. No.: 19/650,185

(22) Filed: Apr. 16, 2026

Related U.S. Application Data
(60) Provisional application No. 63/794,071, filed on Apr. 24, 2025.

(51) Int. Cl. G06T 15/20

(52) U.S. Cl. CPC G06T 15/20

(57) ABSTRACT

Techniques include systems and methods for generative view synthesis with a diffusion model. An image generation system may be configured to (i) receive an input image that depicts an object from a first virtual camera pose, along with an indication of a set of virtual camera poses; (ii) provide the input image and the set of virtual camera poses as input to one or more encoding models, wherein the encoding models are configured to (iii) generate cross attention, image embeddings, and pose embeddings; (iv) provide the cross attention, the image embeddings, and the pose embeddings as input to a diffusion model; and (v) generate a first set of images with the diffusion model that depicts the object from the set of virtual camera poses.

### CROSS REFERENCE TO RELATED APPLICATIONS

This application claims the benefit of and priority to U.S. Provisional Application No. 63/794,071, filed Apr. 24, 2026, and titled “Generative View Synthesis With Diffusion Model,” the content of which is herein incorporated by reference in its entirety for all purposes.

### BACKGROUND

Artificial Intelligence (AI) models (e.g., generative artificial intelligence models) have gained mainstream attention recently for their capabilities. In particular, AI models that generate images and videos have gained widespread interest for their ability to produce novel views from sparse input. Accordingly, and despite the impressive progress that has been made in the field of machine learning, existing techniques for training artificial intelligence models and using artificial intelligence models could be further improved.

### BRIEF DESCRIPTION OF THE DRAWINGS

Features, embodiments, and advantages of the present disclosure are better understood when the following Detailed Description is read with reference to the accompanying drawings.

FIG. 1 is a block diagram illustrating an example system, according to certain embodiments.

FIG. 2 is a block diagram illustrating a training sample, according to certain embodiments.

FIG. 3 is a flow diagram illustrating a training system architecture, according to certain embodiments.

FIG. 4 is a flow diagram illustrating a U-net of a diffusion model, according to certain embodiments.

FIG. 5 is a flow diagram illustrating an inference system architecture, according to certain embodiments.

FIG. 6 is a flow diagram illustrating a training method, according to certain embodiments.

FIG. 7 is a flow diagram illustrating an inference method, according to certain embodiments.

FIG. 8 is a depiction of a virtual scene illustrating an object, a camera pose, a camera pose trajectory orbit, and a corresponding novel view of the object with a different camera pose positioned at a different place in the camera pose trajectory orbit, according to certain embodiments.

FIG. 9 is a depiction of a User Interface (UI), according to certain embodiments.

FIG. 10 is a depiction of various camera path options, according to certain embodiments.

FIG. 11 is depiction of a sub-system of a computing system, according to certain embodiments.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Conventional novel view synthesis (NVS) pipelines broadly fall into two categories: regression-based approaches that deterministically render target views, often via intermediate 3D representations, and diffusion-based approaches that iteratively sample target views from conditional distributions to accommodate uncertainty in unobserved regions, and diffusion-based methods that sample target views from conditional distributions to accommodate uncertainty and diversity in unseen regions. Regression-based approaches can maintain persistent scene consistency but commonly require tens or hundreds of posed input images and struggle to creatively synthesize occluded or unobserved areas, limiting practicality in sparse-view regimes and in-the-wild captures. Diffusion-based approaches include image models trained on unordered sets, which may have mediocre results for set NVS, yet often exhibit multi-view inconsistency and flicker when used to generate trajectories, and video models trained on ordered sequences, which can improve temporal smoothness but frequently impose rigid input/target ordering and are biased toward smaller camera motions prevalent in video datasets.

Existing solutions, whether regression-based or diffusion-based, can struggle to generate large viewpoint changes or temporally smooth samples, while relying on specific task configurations, such as a fixed number of input and target views. Additionally, their sampling consistency may often be insufficient, necessitating additional Neural Radiance Fields (NeRF) distillation to fuse inconsistent results into a coherent representation. For example, given limited or insufficient input coverage, regression-based pipelines that rely on persistent 3D representations struggle to reconstruct missing or occluded regions, often producing blurry, incomplete, or geometrically inaccurate target views, while diffusion image models trained on unordered sets may hallucinate textures inconsistently across viewpoints under large baseline changes.

Training and inference practices in existing solutions can further induce instability and artifacts when scaling to long trajectories or large sets of target views. For example, single-pass generation over long trajectories can introduce temporal flicker and abrupt visual changes, while naive chunking across multiple passes can degrade coherence unless shared frames or anchors are judiciously managed to preserve local consistency. For long trajectories, reusing anchors based on temporal proximity rather than spatial neighborhood can undermine long-range 3D consistency, loop closure, and stability at recurring viewpoints. Moreover, mismatches between the total number of inputs plus target frames used at inference and a fixed context window employed during training can shift attention distributions: shorter than trained windows may yield color overflow artifacts when not padded, while much longer windows in sparse-view regimes may yield excessive blurriness, with padding strategies materially affecting stability.

Embodiments discussed herein address these and other challenges. Specifically, by implementing a procedural two-pass sampling strategy and chunking mechanism of target, the disclosed systems achieve improved temporal smoothness and reduced flickering across generated frames, even over arbitrary and extended camera trajectories. Furthermore, by utilizing a spatial memory bank to retrieve previously generated anchor views based on spatial proximity rather than temporal proximity, the claimed systems can ensure long-range 3D consistency without needing NeRF distillation or explicit 3D representations. These technical improvements can overcome the coherence, stability, and scaling limitations of conventional regression-based and diffusion-based NVS pipelines, enabling highly flexible, continuous view generation in both sparse and semi-dense view regimes.

In an example, an image generation system can include an image sequence generation system, one or more non-transitory storage media storing instructions, and one or more processors operatively coupled to the image sequence generation system and configured to execute the instructions to perform image synthesis operations described herein.

In some embodiments, the one or more processors can be configured, by execution of the instructions, to receive an input image that depicts an object from a first virtual camera pose and to receive an indication of a set of virtual camera poses.

In other embodiments, the one or more processors can be further configured to generate, by providing the input image and the set of virtual camera poses to the image sequence generation system, a first set of images depicting the object from the set of virtual camera poses

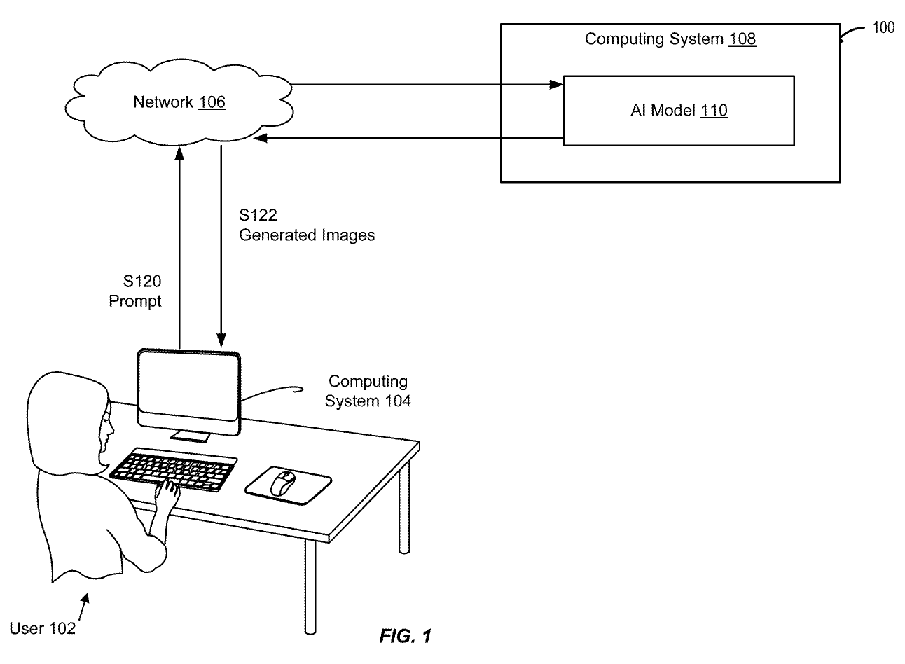

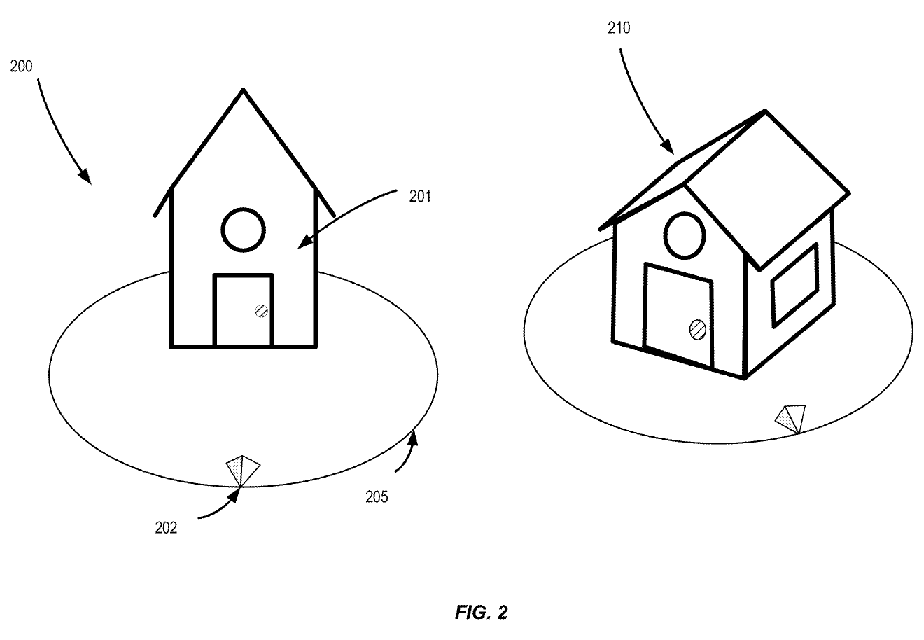

FIG. 1 illustrates an exemplary system architecture 100 in accordance with various embodiments. As depicted, a user 102 may interact with a computing system 104, which may communicate with a computing system 108 via a network 106. The computing system 104 may constitute any suitable user device, including but not limited to a desktop computer, a laptop computer, a tablet computing device, a smartphone, a workstation, a thin client, a virtual machine instance, a gaming console, a smart television, or any other computing apparatus capable of transmitting and receiving data over a network. The network 106 may constitute any suitable communication infrastructure, including but not limited to the Internet, a local area network (LAN), a wide area network (WAN), a metropolitan area network (MAN), a wireless network (such as Wi-Fi, cellular, or satellite-based networks), a virtual private network (VPN), a peer-to-peer network, or any combination thereof. The computing system 108 may constitute any suitable server-side computing infrastructure, including but not limited to a single server, a server cluster, a cloud computing platform, a distributed computing system, an edge computing node, a data center, or a combination of on-premises and cloud-based resources.

In operation, the computing system 104 may transmit a prompt S120 to the computing system 108 via the network 106. The prompt S120 may constitute a request for generated images and may include various components. For example, the prompt S120 may include an input image depicting an object, or alternatively may indicate a storage location (such as a uniform resource locator, a file path, or a cloud storage reference) from which a target image may be retrieved. The prompt S120 may further include configurable parameters specified by the user via a user interface to be applied to the object depicted in the target image. In certain implementations, the prompt S120 may include selecting a trajectory, a number of frames, a random seed, a chunk strategy, a CFG value, or a camera scale. A single reference image may be sufficient to form the generated images, no additional images or video frames need be provided via the user interface.

Responsive to receiving the prompt S120, the computing system 108 may generate images and transmit the generated images S122 back to the computing system 104 via the network 106 (or may store the generated images at a network location and may send the address of the network location to the computing system 104 via the network 106). The generated images S122 may constitute, for example, a temporally coherent video sequence depicting the object from the reference image as viewed from different positions along a camera path, according to the configurable parameters specified in the prompt S120. The generated images S122 may alternatively or additionally include other formats as described above, such as animated image sequences, sprite animations, motion graphics, or other multimedia representations.

To form generated images S122, the computing system 108 may include an AI model 110. The AI model 110 may constitute a diffusion model or other generative model as described herein. The AI model 110 may be trained to form generated images directly from the reference image without necessitating an adapter module, a pose adapter, or other post-processing algorithms. The AI model 110 may generate novel views of a static object by simulating extrinsic camera motion by utilizing a training strategy for jointly modeling large viewpoint changes and temporal smoothness and a two-pass procedural sampling method for smooth video generation along arbitrary long camera trajectories. As utilized herein, a “AI model”, may refer to an image generation system configured to perform NVS.

The generative process executed by the image generation system to achieve novel view synthesis is further described herein. In various embodiments, the image generation system may be implemented as a multi-view diffusion model that is trained to generate novel views from input images without needing an explicit intermediate 3D representation. For example, as illustrated in FIG. 2, an input image may provide a frontal view of an object, such as a house. In said example, the image generation system may be configured to generate a novel view of the house from a different position along a camera path by synthesizing previously occluded geometry, such as the side walls and roof structure, resulting in a Three-Dimensional (3D) rendering of the object from the different position along the camera path.

As further illustrated in FIG. 2 a first frame 200 comprises an object 201 and an associated camera pose 202. In the depicted embodiment, object 201 is shown as a house, and camera pose is illustrated as a pyramid-shaped icon positioned in front of the house and along a camera pose trajectory orbit 205, wherein the camera pose trajectory orbit represents a set of possible camera trajectories for synthesizing the object.

A second frame 210 in FIG. 2 comprises the same object 201 as viewed from a separate, novel viewpoint. Here, the house is rendered in three-dimensional perspective, revealing additional geometric features such as the side wall and window that are not visible in the first frame. The associated camera pose 202 is now positioned at a different location along the camera pose trajectory orbit 205 and is oriented to capture the new perspective.

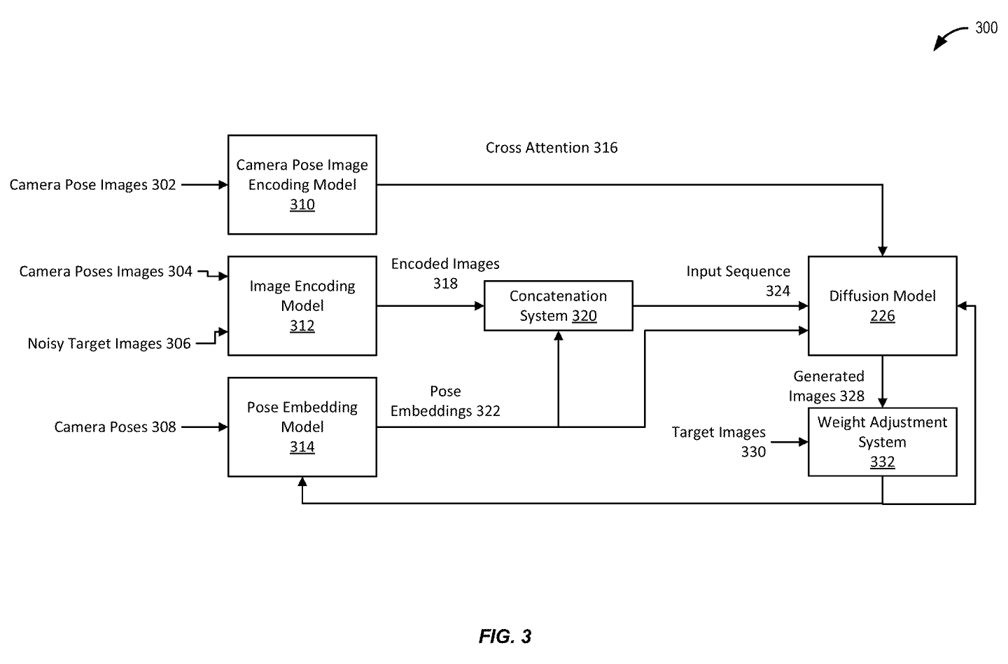

In some embodiments, the generation of the second frame 210 from the object 201 in the first frame 200 may be enabled by a multistage training method for jointly modeling large viewpoint changes and temporal smoothness. The multistage training method may further be configured to train the diffusion model of the image generation system and comprise a training architecture shown in FIG. 3.

As illustrated in FIG. 3, the training architecture of the image generation system 300 may comprise a Camera Pose Image Encoding Model 310 which is configured to receive camera pose images 302 (e.g., first camera pose image, second camera pose image, etc.); an Image Encoding Model 312 which is configured to receive camera poses images 304 and noisy target images 306; and a Pose Embedding Model 314 which is configured to receive camera poses 308 (e.g., first camera pose, second camera pose, etc.). In some embodiments, the Camera Pose Image Encoding Model may be configured as a Contrastive Language-Image Pre-training (CLIP) model, the Image Encoding Model may be configured as a Variational Autoencoder (VAE), and the Pose Embedding Model may be configured as a Plucker-Embedding Model.

In some embodiments, the Camera Pose Image Encoding Model 310 may be configured to receive, as input, the camera pose images 302, the Image Encoding Model 312 may be configured to receive, as input, the camera poses images 304 and the noisy target images 306, and the Pose Embedding Model 314 may be configured to receive, as input, the camera poses 308.

As utilized herein, the camera poses images 302 may refer to the set of one or more known, ground-truth images provided to the model as conditional information, wherein each image is paired with a corresponding, known camera pose that defines the specific viewpoint from which it was captured, and which serve as the visual and spatial context for the generative process; the camera poses images 304 may refer to the set of one or more ground-truth images that the model is being trained to generate, wherein each image is associated with a target camera pose also provided to the model as a conditioning input, and wherein the latent representations of these images serve as the ground truth against which the model's final, denoised output is compared to calculate the training loss; the noisy target images 306 may refer to the latent representations of the ground-truth target images over which a predetermined amount of noise has been algorithmically added, serving as the initial state that the multi-view diffusion model is trained to progressively denoise to predict the final, clean target images; and the camera poses 308 may refer to the set of parameters that precisely define a virtual camera’s position, orientation, and optical properties in 3D space, typically comprising extrinsic parameters (e.g., a 4x4 matrix defining rotation and translation) and intrinsic parameters (e.g., focal length), which are converted into a dense, pixel-wise representation such as Plücker embeddings to effectively condition the generative process.

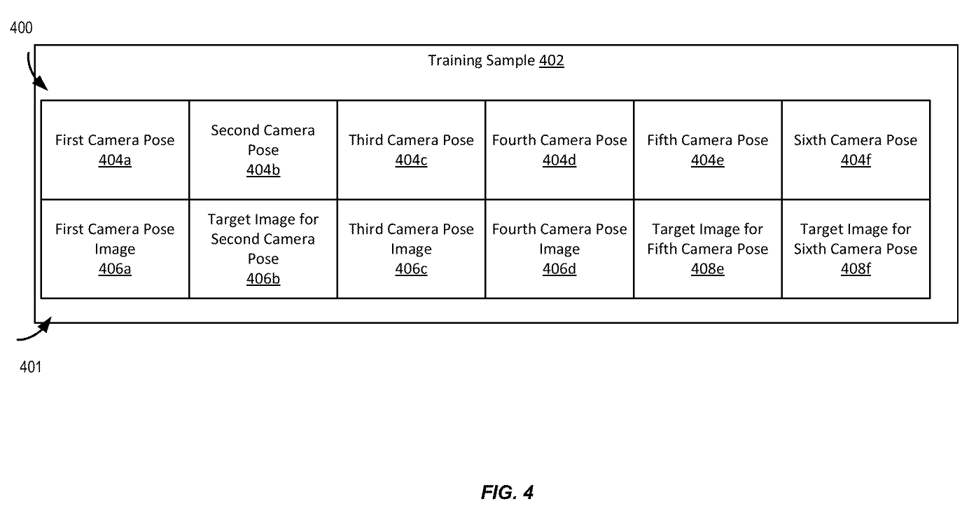

In certain embodiments, the camera pose images 302, the camera poses images 304, the noisy target images 306, and the camera poses 308 may be associated with a training sample 402, shown in FIG. 4, from a plurality of training samples.

FIG. 4 is a repersentation of the training sample 402 from the pluarlity of training samples, according to certain embodiments. The training sample 402 may further comprise an image or a sequence of images with a set of M input images 400 and a set of N traget images 401. For each training sample, a set of M input images (with their camera poses) and N target images (with their camera poses) is selected.

The set of M input images 400 may comprise a first camera pose 404a, a second camera pose 404b, a third camera pose 404c, a fourth camera pose 404d, a fifth camera pose 405e, and a sixth camera pose 404f.

The set of N target images 401 may comprise a first camera pose image 406a, a target image for second camera pose 406b, a third camera pose image 406c, a fourth camera pose image 406d, a target image for fifth camera pose 408e, and a target image for sixth camera pose 408f.

In further embodiments, the set of M input images 400 may be associated with the camera poses images 402 and the camera poses images 304; the set of N target images 401 may be associated with the camera poses images 304 and the noisy target images 306; and the set of M input images 400 and the set of N input images 401 is associated with the camera poses 308.

Referring back to FIG. 3, in certain embodiments, the Camera Pose Image Encoding Model 310 may be configured to process the camera pose images 302 and generate Cross Attention 316; the Image Encoding Model 312 may be configured to process the camera poses images 304 and noisy target images 306 to generate encoded images 318; and the Pose Embedding Model 314 may be configured to process the camera poses 308 and generate pose embeddings 322.

As utilized herein, the cross attention 316 may refer to a neural network mechanism within the diffusion model architecture that causes the generative process to be conditioned on high-level semantic information. In various embodiments, this mechanism enables the model to attend to global image features, such as CLIP embeddings averaged over the input views, thereby guiding the synthesis of the target views to ensure they are semantically consistent with the provided input content; the encoded images 318 may refer to compressed, lower-dimensional latent representations of the input images, generated by passing the images through the Image Encoding Model. These representations capture the essential semantic and structural features of the images in a computationally efficient format suitable for processing by a U-Net architecture of the diffusion model; and the pose embeddings 322 may refer to a dense, learned vector representation of the camera poses, which transforms the discrete extrinsic and intrinsic camera parameters into a continuous, high-dimensional, and spatially-aware format. In one embodiment, this is achieved using Plücker coordinates to generate a per-pixel representation of camera rays, which is then concatenated with the encoded image latents to provide a precise geometric conditioning signal to the model.

As further illustrated in FIG. 3, the training model may comprise a Concatenation System 320 which is configured to receive the encoding images (4-channel tensor) and the pose embeddings to generate an input sequence 324 (10-channel tensor). As utilized herein, the input sequence may comprise a sequence of multi-channel tensors, one for each view in the training sample, with each tensor encoding the visual content, spatial orientation, and a binary mask differentiating input from target views and configured to be input to the diffusion model 226.

In certain embodiments, the diffusion model 226 may be configured to receive the input sequence 324, the pose embeddings 322, and the cross attention 316 and to output generated images 328 based on the input sequence 324, the pose embeddings 322, and the cross attention 316.

In further embodiments, the Weight Adjustment System 332, of FIG. 3, may be configured to receive the generated images and the target images 330 and compute a loss function based on a discrepancy between the latent representations of the generated images 328 and the target images 330 (ground-truth). Then, based on the results of the loss function, the Weight Adjustment System 332 modifies trainable parameters of the training architecture 300.

As utilized herein, the “trainable parameters” of the training architecture may refer to parameters (e.g., weights and biases) associated with the diffusion model 226 and the Pose Embedding Model 314. Alternate parameters associated with the Camera Pose Image Encoding Model 310 and the Image Encoding Model 312 are “locked” or kept static during training.

In said embodiments, the training architecture may be configured with a conditional loop based on a condition of a current number of iterations meeting a required number of iterations. Following an indication that a first iteration of training is complete and the trainable parameters are adjusted by the Weight Adjustment System based on the loss function, the training architecture updates the current number of iterations and starts a second training iteration with a second set of input images from the plurality of training images. The training architecture is configured to repeat this process for each iteration, incrementing the current iteration count, until the current number of iterations meets the required number of iterations.

In exemplary embodiments, upon an indication that the current number of iterations is equal to the required number of iterations the image generation system may be configured to output a diffusion model 226 to be used at Inference.

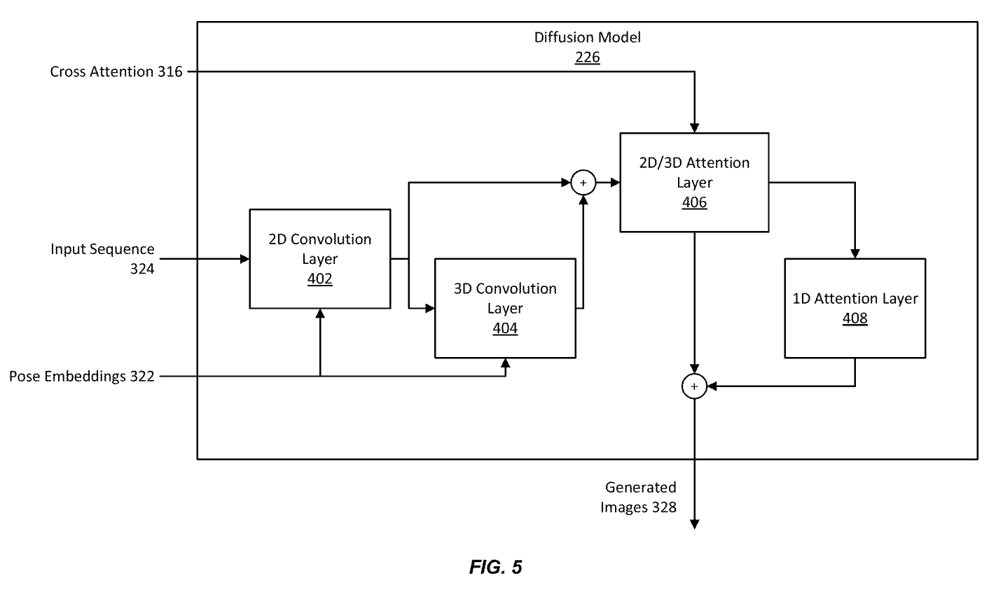

As illustrated in FIG. 5, the Diffusion Model 226 may be configured to receive cross attention 316, an input sequence 324, and pose embeddings to output generated images 328. In certain embodiments, the Diffusion Model may further comprise a U-net architecture with a two-dimensional (2D) convolution layer 402, a three-dimensional (3D) convolution layer 404, a 2D/3D attention layer 406, and a one-dimensional (1D) Attention layer 508.

In certain embodiments, the training architecture may be configured with an optional video training stage that may be enabled based on an indication that the required number of iterations of the training method is equal to the current number of iterations (when training is complete). For example, upon reaching a required number of iterations (e.g., 600,000) the optional video training stage may be enabled. When enabled, the optional video training stage may execute an additional number of training iterations (e.g., 200,000).

In further embodiments, the optional video training stage may be configured to train the diffusion model of the image generation system for the additional number of training iterations. Wherein training the diffusion model during the optional video training stage further comprises, receiving, as input, data from an ordered set of input images (e.g., consecutive frames in a video) from the plurality of training samples, wherein the data from the ordered set of input images may comprise the input sequence 324, the pose embeddings 322, and the cross attention 316.

The optional video training stage may be configured to process the data along a data path of residual blocks comprising the 2D Convolution Layer; the 3D Convolution Layer; the 2D/3D Attention, and the 1D Attention Layer. For example, processing the data along the data path within the Diffusion Model 226 begins when the input sequence 324 and the pose embeddings 322 are received by the 2D Convolution Layer 402. Concurrently, the Pose Embeddings 322 are provided as input to the 3D Convolution Layer 404. An output feature map from the 2D Convolution Layer 402 is then passed as input to the 3D Convolution Layer 404. Subsequently, the output of the 3D Convolution Layer 404 is combined with the output from the 2D Convolution Layer 402 and received by the 2D/3D Attention Layer 406, which is further conditioned by the cross attention 316 for semantic conditioning. Then, the output of the 2D/3D Attention Layer 406 is received by the 1D Attention Layer 408. The outputs from both the 2D/3D Attention Layer 406 and the 1D Attention Layer 408 are combined to form a final denoised feature map, which is used to form the generated images 328. In the video training stage, the trainable parameters associated with the Pose Embedding Model and the Diffusion Model are locked. Rather, the video training stage comprises temporal weights associated with the 3D Convolution Layer of the U-net of the Diffusion Model. In such embodiments, the temporal weights may be configured as floating point values and associated with adjusting the 3D Convolution Layer. In alternate embodiments, before an indication that training is complete, the optional video training stage may be disabled.

The processing performed using the training system architecture described above with respect to FIG. 3 may be implemented using a method of training. Examples of such a method are described below with respect to the method of FIG. 3.

The processing depicted in method 600 and any other FIGS. may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in method 600, and other FIGS. described herein are intended to be illustrative and non-limiting. Although method 600, and other FIGS., depict the various processing steps occurring in a particular sequence or order, this is not intended to be limiting. In certain alternative embodiments, the processing may be performed in some different order or some steps may also be performed in parallel. It should be appreciated that in alternative embodiments the processing depicted in method 600, and other FIGS., may include a greater number or a lesser number of steps than those depicted in the respective FIGS.

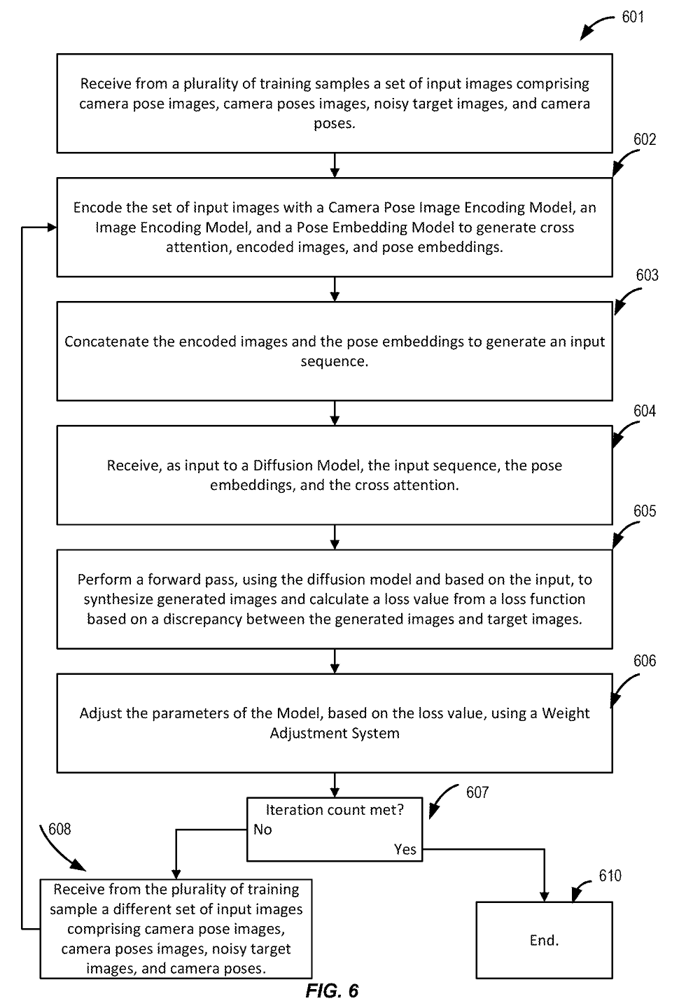

FIG. 6 shows an example method 600 of training 700, according to certain embodiments of the present disclosure. The method 600 may be performed by the training system 300 described above.

As illustrated in FIG. 6, an example method 600 for training an image generation system further comprises: at 601, receiving, from a plurality of training samples, a set of input images comprising camera pose images, camera poses images, noisy target images, and camera poses; at 602, encoding, the set of input images with a Camera Pose Image Encoding Model, an Image Encoding Model, and a Pose Embedding Model to generate cross attention, encoded images, and pose embeddings; at 603, Concatenating, the encoding images and the pose embeddings to generate an input sequence; at 604, receiving, as input to a Diffusion Model, the input sequence, the pose embeddings, and the cross attention; at 605, performing a forward pass, using the diffusion model and based on the input, to synthesize generated images and calculate a loss value from a loss function based on a discrepancy between the generated images and target images; at 606, Adjust trainable parameters of the Model, based on the loss value, using a Weight Adjustment System; at 607, check if an iteration count is met: if met, proceed to 610 and end training, otherwise proceed to 608, and receive from the plurality of training samples different set of input images comprising different camera pose images, camera poses images, noisy target images, and camera poses and procced to step 602.

In various embodiments, the process of receiving and encoding the input images (601-604) are implemented as follows. At 601, a set of input images from the plurality of training samples is received, and a sequence of camera pose images is divided into a set of M input 400 images and N target images 401. At 602, these images are processed through parallel encoding paths: the Camera Pose Image Encoding Model 310 (e.g., a frozen CLIP model) processes the M input images 400 to generate a single semantic vector for the cross attention 316; the Image Encoding Model 312 (e.g., a frozen VAE) processes the M input images 400 and N target images 401 into their latent representations to form the encoded images 318; and the Pose Embedding Model 314 (e.g., a trainable Plücker-Embedding Model) converts the camera poses 308 for all M+N images into pose embeddings 322. At 603, the encoded images 318 (latents) and their corresponding pose embeddings 322 are concatenated on a per-view basis to generate the input sequence 324. At 604, the Diffusion Model receives the input sequence 324, the pose embeddings 322, and the cross attention 316 vector as inputs to the U-Net architecture.

The process of performing a forward pass (605) may be implemented as a multi-stage training process designed to train the training architecture 300 on both large-scale generation and fine-grained interpolation. For example, a training context window length, T, is defined as a sum of input images M and target images N. In a first stage, the model is trained on a shorter context window of T = 8 with a required iteration count (e.g., 100,000) using a specific batch size (e.g., 1472). In a second stage, the training architecture is trained on a longer context window of T = 21 for a greater number of iterations (e.g., 600,000) with a different batch size (e.g., 512). For each forward pass within a training stage, the number of input frames M ∈ [1, T −1] and the frames which comprise a set of input images and a set of target images (Iinp, Itgt) are randomly sampled. Additionally, for each training stage, the signal-to-noise-ratio (SNR) is shifted based on requiring more noise to destroy the information when training with more frames. In such embodiments, the model may be configured to receive square images with a height and width of 576 pixels (H = W = 576).

In various embodiments, the process of adjusting the trainable parameters of the image generation system (606) is implemented, in nonlimiting examples, by using a backpropagation algorithm and a stochastic gradient-based optimizer, such as an Adam optimizer. A loss value, calculated from the loss function at 605, serves as the error signal that is propagated backward through the network to compute gradients for each of the model's trainable parameters. The Weight Adjustment System 332 then uses the gradients to update the trainable parameters in a direction that is determined to minimize the loss function over subsequent training iterations. Critically, this adjustment is selectively applied only to the trainable parameters of the training architecture 300. Specifically, the parameters of the diffusion model 226, associated with the 2D Convolution Layer 402, 3D Convolution Layer 404, 2D/3D Attention Layer 406, and 1D Attention Layer 408, are adjusted. Additionally, the parameters of the Pose Embedding Model 314 are updated to learn the optimal representation for the camera poses. In contrast, the parameters of the Camera Pose Image Encoding Model (e.g., CLIP) and the Image Encoding Model (e.g., VAE) remain frozen and are not adjusted at 705.

As utilized herein, the “loss value” calculated from the loss function may refer to a numerical or integer value associated with a measure of the diffusion model’s 226 error for a set of input images in the plurality of training samples. For example, a high loss value indicates a large discrepancy between the generated images and the target images (ground truth). Accordingly, a high loss value indicates the model's current parameters are not well suited for the set of input images and causes the Weight Adjustment System 332 to make a more significant adjustment of the trainable parameters of the training architecture 300. Conversely, a low loss value indicates a small discrepancy between the generated images 328 and the target images 330. Accordingly, a low loss value indicates the model's current trainable parameters are well suited for the set of input images and causes the Weight Adjustment System 332 to make a less significant adjustment of the trainable parameters of the training architecture 300. In non-limiting examples, the trainable parameters may comprise parameters associated with the Diffusion model and the Pose Embedding Model (temporal weights, biases, etc.).

The conditional check (607) may be configured as a control flow mechanism that governs the duration and structure of the training method. In practice, the training architecture 300 maintains a current iteration count that is incremented each time a batch of training samples is processed and the model's parameters are adjusted (i.e., after each completion of 606). At 607, the current iteration count is compared against the required iteration count. For example, during a first stage of the training method, the required iteration count is set to a specific value (e.g., 100,000 iterations). If the current iteration count is less than this target, the condition is not met, and the system proceeds to step 608 to receive a new set of input images from the plurality of training samples, and the training loop continues from 602. When the current iteration count is equal to the required iteration count, the first training stage is complete. The system may then proceed to a second stage, with updated trainable parameters (e.g., the context window length is increased to T=21), the current iteration counter is reset, and a new, higher required iteration count (e.g., 600,000) is set. The training method again traverses the loop, updating the trainable parameters based on the loss value for each iteration, until the current number of iterations is equal to the new required number of iterations. Upon completion of the final training stage, the condition at step 707 is met for the last time, and the system proceeds to step 710, concluding the training process.

In some embodiments, the training method 600 may be configured as a multi-stage training process and operate as a conditional loop based on whether the required iteration count is equal to the current iteration count. As utilized herein, the “required iteration count” may refer to a numerical or integer value associated with a predetermined number of training iterations that constitutes a complete training cycle and the “current iteration count” may refer to a numerical or integer value that is maintained by the training architecture 300 and configured to increment that increases each time the training method proceeds to step 608 (e.g., 1 for the first stage, 2 for the second stage, etc.). The training method traverses the loop: receiving a set of input images from a plurality of training samples; encoding the set of input images to generate cross attention 316, encoded images 318, and pose embeddings 322; receiving, by the diffusion model 226, the cross attention 316, encoded images 318, and pose embeddings 322, to perform a forward pass and form the generated images 328; receiving, by a Weight Adjustment Model 332, the generated images 328 and target images 330, to calculate a loss value from a loss function; and adjusting, based on the loss value, the trainable parameters of the training architecture 300 . Following an adjustment to the trainable parameters, a conditional check is performed at 607 to determine if the current iteration count is equal to the needed iteration count. Upon an indication that the current iteration count is less than the required iteration count, the training method proceeds to step 608 and repeats the loop with a different set of input images from the plurality of training samples, otherwise, if the current iteration count is equal to the required iteration count the system proceeds to 610 and exits the conditional loop.

In other embodiments, components of the training method 600 may comprise parameters which are not adjusted during training and intentionally kept static, or "locked". For example, parameters associated with the Camera Pose Image Encoding Model 310 and the Image Encoding Model 312 remain the same throughout each and every iteration of the training method regardless of the loss value calculated from the loss function. As such, the training method may be configured to isolate the training to specific novel challenges of multi-view synthesis, specifically, aspects associated with 3D geometry and maintaining cross-view consistency. By limiting the trainable parameters to the parameters of the Diffusion Model 226 and the Pose Embedding Model 314, the training method operates with faster convergence, more stability, and less computational overhead.

In certain embodiments, an optional video training stage may be enabled based on an indication that the needed number of iterations of the training method is equal to the current number of iterations or an indication of a user input. For example, when the required iteration count is equal to the current iteration count (the optional video training stage may be enabled for an additional number of training iterations (e.g., 200,000). Conversely, upon an indication that the current iteration count is less than the required iteration count. the optional video training stage may be disabled. In the optional video training stage, the trainable parameters associated with the Pose Embedding Model 322 and the Diffusion Model 226 are locked. Rather, the optional video training stage comprises temporal weights associated with the 3D Convolution Layer 504 of a plurality of layers in the U-net of the Diffusion Model. As utilized herein,, the “temporal weights” may refer to floating point values and are associated with adjusting the 3D Convolution Layer 504.

The optional video training stage may be configured to process data along a data path of layers in the plurality of layers of the U-Net architecture comprising: the 2D Convolution Layer 402; the 3D Convolution Layer 404; the 2D/3D Attention 406, and the 1D Attention Layer 508. For example, processing the data along the data path within the Diffusion Model 226 begins when the input sequence 324 and the pose embeddings 322 are received by the 2D Convolution Layer 402. Concurrently, the pose embeddings 322 are provided as input to the 3D Convolution Layer 404. The output data from the 2D Convolution Layer 402 is then provided as input to the 3D Convolution Layer 404. Subsequently, the data output of the 3D Convolution Layer 404 is combined with the data output from the 2D Convolution Layer 402 and provided as input to the 2D/3D Attention Layer 406, which is further conditioned by the cross attention 216 for semantic conditioning. Then, the data output of the 2D/3D Attention Layer 406 is provided as input to the 1D Attention Layer 408. The data outputs from both the 2D/3D Attention Layer 406 and the 1D Attention Layer 408 are combined to form a final data output, which is used by the diffusion model 226 to form the generated images 328.

As utilized herein, the term “data” may refer to the cross attention 316, the pose embeddings 322, and the input sequence 324 generated from the set of input images by the training architecture 300.

In various embodiments, the 2D Convolution Layer 402 is configured to perform the initial feature extraction on the data. It receives the input sequence 324, which comprises the latent representations of the M input and N target views, and the pose embeddings 322. The 2D Convolution Layer 402 applies a series of 2D convolutional filters to each view in the sequence independently and extracts spatial features, such as edges, textures, and shapes, from within each individual frame. Additionally, the use of the pose embeddings 322 as input causes the spatial feature extraction to be pose-aware from the outset, allowing the diffusion model 226 to learn features that are relevant to a specific viewpoint.

The data output of the 2D Convolution Layer 402 is then input to the 3D Convolution Layer 404, which also receives the pose embeddings 322 as a conditioning input. Unlike the 2D Convolution Layer 402, the 3D Convolution Layer 404 is configured to operate across multiple frames simultaneously. It applies spatio-temporal filters that process a volume of data spanning both the spatial dimensions (height and width) and the view dimension. This allows the diffusion model 226 to capture local motion and short-range temporal relationships between adjacent frames in the sequence, which is critical for generating smooth video transitions.

As utilized herein, the “data output” may refer to a feature map, which is a multi-dimensional tensor representing a transformed state of the data after being processed by a neural network layer. The feature map no longer comprises the raw data of the input (such as initial latent representations or embeddings) comprises learned, hierarchical representations of features relevant to the diffusion model's 226 task. For example, the data output of the 2D Convolution Layer 402 may be a feature map wherein the input sequence 324 is transformed to represent learned spatial features (e.g., edges and textures) which may be used as input to subsequent layers in the plurality of layers of the U-Net architecture.

Next, the feature maps from both the 2D Convolution Layer 402 and the 3D Convolution Layer 404 are combined. The combination of feature maps enables for a more comprehensive feature representation that contains both detailed intra-frame spatial information (from the 2D layer) and local inter-frame temporal information (from the 3D layer). The combined feature map is then provided as input to the 2D/3D Attention Layer 406.

The 2D/3D Attention Layer 406 may be configured establish long-range spatial and multi-view consistency. When the optional video training stage is enabled, the 2D/3D Attention Layer 406 allows each position in the feature map to attend to all other positions across the entire sequence of views. This is essential for ensuring that the generated scene is geometrically coherent from all perspectives (e.g., ensuring a feature visible in one view appears correctly in another). The 2D/3D Attention Layer 406 is further conditioned by the cross attention 316 signal, which injects high-level semantic information (e.g., "this is a house") to guide the generative process.

Finally, the feature map generated by the 2D/3D Attention Layer 406 is input to the 1D Attention Layer 408, which performs a computationally efficient attention operation specifically along the view axis, further refining the relationships between the different views in the sequence to generate a feature map. The feature map from the 1D Attention Layer 408 is then combined with the output of the 2D/3D Attention Layer 406. This final combination, akin to a residual connection, produces a denoised feature map to be used by the diffusion model 226 to form the generated images 328.

The training method 600 may be configured to proceed through the multi-stage training process and adjust the trainable parameters for each iteration of the multi-stage training process and until the current iteration count is equal to the required iteration count. In cases where the optional video training stage is enabled, the training method 600 may proceed through the multi-stage training process until the required iteration count is equal to the current iteration count and then proceed through the optional video training stage for an additional number of iterations to train the temporal weights of the diffusion model 226. In cases where the optional video training stage is disabled, the training method 600 may proceed through the multi-stage training process until the required iteration count is equal to the current iteration count.

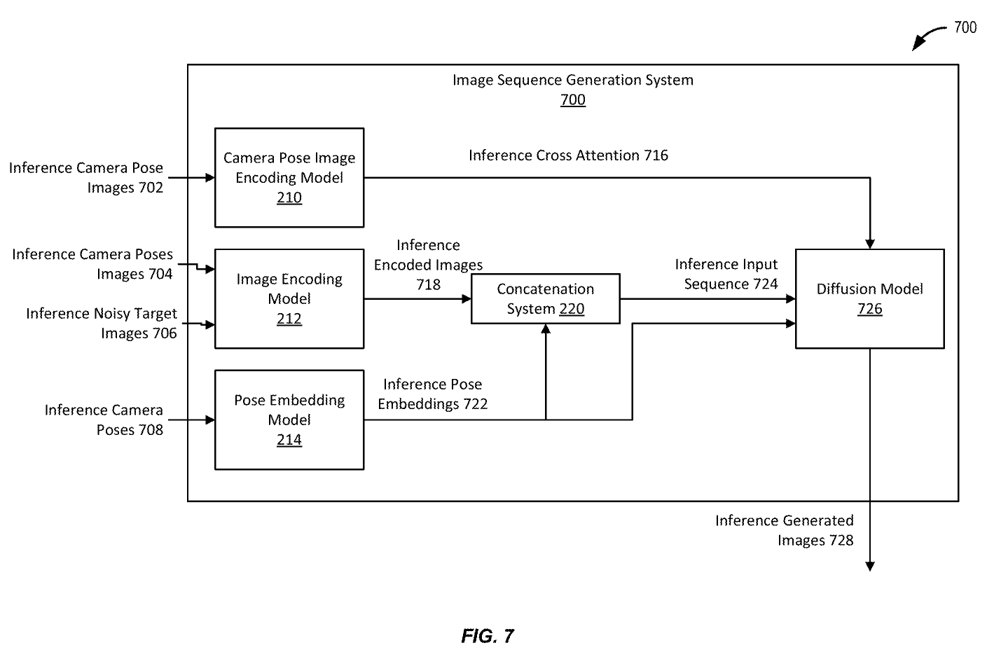

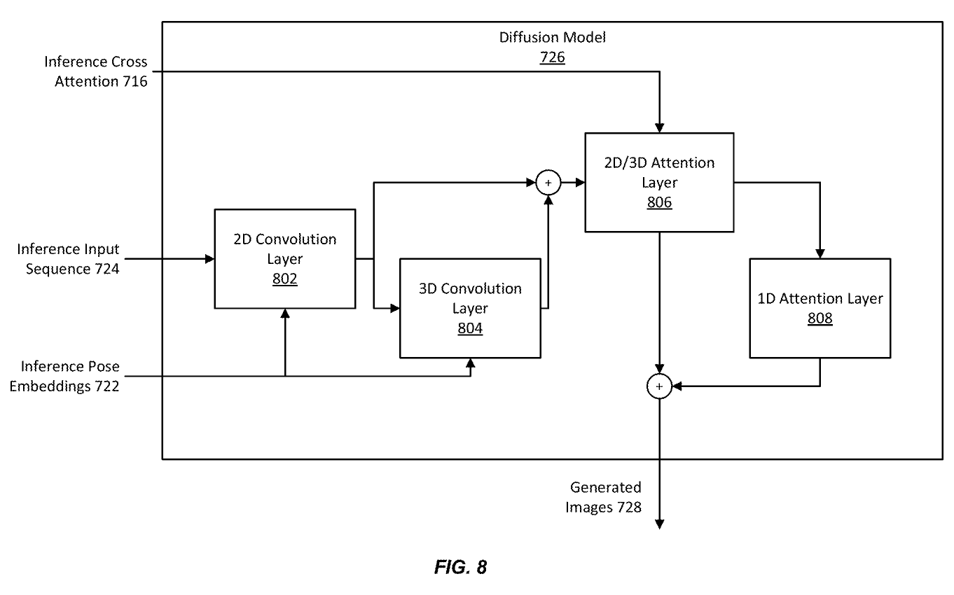

The training method 600 may be configured to train the image generation system 750 which comprises an inference architecture 700 as shown in FIG. 7. Additionally, the training method 600 may be configured to train the diffusion model 226 to serve as a diffusion model 726 of the inference architecture 700. As utilized herein, the “diffusion model 726” may represent a trained version of the diffusion model 226 following the completion of the multi-stage training process.

As illustrated in FIG. 7, the inference architecture 700 of the image generation system 750 may comprise a Camera Pose Image Encoding Model 210 which is configured to receive inference camera pose images 702 (e.g., first camera pose image, second camera pose image, etc.); an Image Encoding Model 212 which is configured to receive inference camera poses images 704 and inference noisy target images 706; and a Pose Embedding Model 214 which is configured to receive inference camera poses 708 (e.g., first camera pose, second camera pose, etc.). In some embodiments, the Camera Pose Image Encoding Model 210 may be configured as a Contrastive Language-Image Pre-training (CLIP) model, the Image Encoding Model 212 may be configured as a Variational Autoencoder (VAE), and the Pose Embedding Model 214 may be configured as a Plucker-Embedding Model.

As utilized herein, the “Pose Embedding Model 214” may represent a trained version of the Pose Embedding Model 314 of FIG. 3 following the completion of the multi-stage training process.

In some embodiments, the Camera Pose Image Encoding Model 210 may be configured to receive, as input, the inference camera pose images 702, the Image Encoding Model 212 may be configured to receive, as input, the inference camera poses images 704 and the inference noisy target images 706, and the Pose Embedding Model 214 may be configured to receive, as input, the inference camera poses 708.

As utilized herein, the inference camera poses images 702 may refer to the set of one or more user-provided images that serve as the conditional input. Each image is associated with a known camera pose, providing the visual and spatial context from which the new views will be synthesized; the inference camera poses images 704 may refer to novel target views that are to be generated by the model, which are initialized with a random noise tensor rather than ground-truth image data; the inference noisy target images 706 a tensor of pure, randomly generated noise (e.g., from a Gaussian distribution) that occupies the latent space of the target views to be generated; and the inference camera poses 708 may refer to the set of all camera poses relevant to inference, including known poses of the input images as well as user-specified target poses that define desired camera trajectory for the generated images.

In certain embodiments, the Camera Pose Image Encoding Model 210 may be configured to process the inference camera pose images 702 and generate inference cross attention 716; the Image Encoding Model 212 may be configured to process the inference camera poses images 704 and inference noisy target images 706 to generate inference encoded images 718; and the Pose Embedding Model 214 may be configured to process the inference camera poses 708 and generate inference pose embeddings 722.

As utilized herein, the inference cross attention 716 may refer to a neural network mechanism within the diffusion model architecture that causes the generative process to be conditioned on high-level semantic information. In various embodiments, this mechanism enables the model to attend to global image features, such as CLIP embeddings averaged over the input views, thereby guiding the synthesis of the target views to ensure they are semantically consistent with the provided input content; the encoded images 718 may refer to compressed, lower-dimensional latent representations of the input images. These representations capture the essential semantic and structural features of the images in a computationally efficient format suitable for processing by a U-Net architecture of the diffusion model; and the pose embeddings 722 may refer to a dense, learned vector representation of the camera poses, which transforms the discrete extrinsic and intrinsic camera parameters into a continuous, high-dimensional, and spatially-aware format. In one embodiment, this is achieved using Plücker coordinates to generate a per-pixel representation of camera rays, which is then concatenated with the encoded image latents to provide a precise geometric conditioning signal to the model.

As further illustrated in FIG. 7, the Inference System Architecture may comprise a Concatenation System 220 which is configured to receive the inference encoded images 718 (4-channel tensor) and the inference pose embeddings 722 to generate an inference input sequence 724 (10-channel tensor). As utilized herein, the inference input sequence 724 may refer to a sequence of multi-channel tensors, with each tensor encoding the visual content, spatial orientation, and a binary mask differentiating input from target views.

In further embodiments, the Diffusion Model 726 may be configured to receive, as input, the inference cross attention 716, the inference input sequence 724, and the inference pose embeddings 722 to generate inference generated images 728.

As illustrated in FIG. 8 the Diffusion Model 726 of the inference architecture in FIG. 7 may be configured to receive the inference cross attention 716, the inference input sequence 724, and the inference pose embeddings 722 to output generated images 728. In certain embodiments, the U-Net architecture of the diffusion model 726 may be configured with a two-dimensional (2D) convolution layer 802, a three-dimensional (3D) convolution layer 804, a 2D/3D attention layer 806, and a one-dimensional (1D) Attention layer 808.

In some embodiments, the 3D convolution layer 804 may be configured as an optional temporal pathway that is enabled during inference, specifically in cases where the user provides an input sequence that is ordered, such as consecutive frames from a video. In said embodiments, the 3D convolution layer 804 may be configured to receive, as input, the inference pose embeddings 722 and an output from the 2D convolution layer 802.

In embodiments where the 3D convolution layer 804 is enabled, the 2D convolution layer 802 may be configured to receive, as input, the inference input sequence 724 and the inference pose embeddings 722. The 3D convolution layer 804 may be configured to receive, as input, the inference pose embeddings 722 and the output from the 2D convolution layer 802. The 2D/3D attention layer 806 may be configured to receive, as input, the inference cross attention 716 and a combination of outputs from the 2D convolution layer 802 and the 3D convolution layer 804. The 1D attention layer 808 may be configured to receive, as input, the inference cross attention 716 and the output from the 2D/3D attention layer 806. The outputs of the 2D/3D attention layer 806 and the 1D attention layer 808 may be combined to form the generated images 728.

In alternate embodiments, the 3D convolution layer 804 may be configured as an optional temporal pathway that is disabled during inference, specifically in cases where the user provides an input sequence that is unordered.

In embodiments where the 3D convolution layer 804 is disabled, the 2D convolution layer 802 may be configured to receive, as input, the input sequence 724 and the pose embeddings 722. The 2D/3D attention layer 806 may be configured to receive, as input, the cross attention 716 and the output from the 2D convolution layer 802. The 1D attention layer may be configured to receive, as input, the cross attention 716 and the output from the 2D/3D attention layer 802. The outputs of the 2D/3D attention layer 806 and the 1D attention layer 808 may be combined to form the generated images 728.

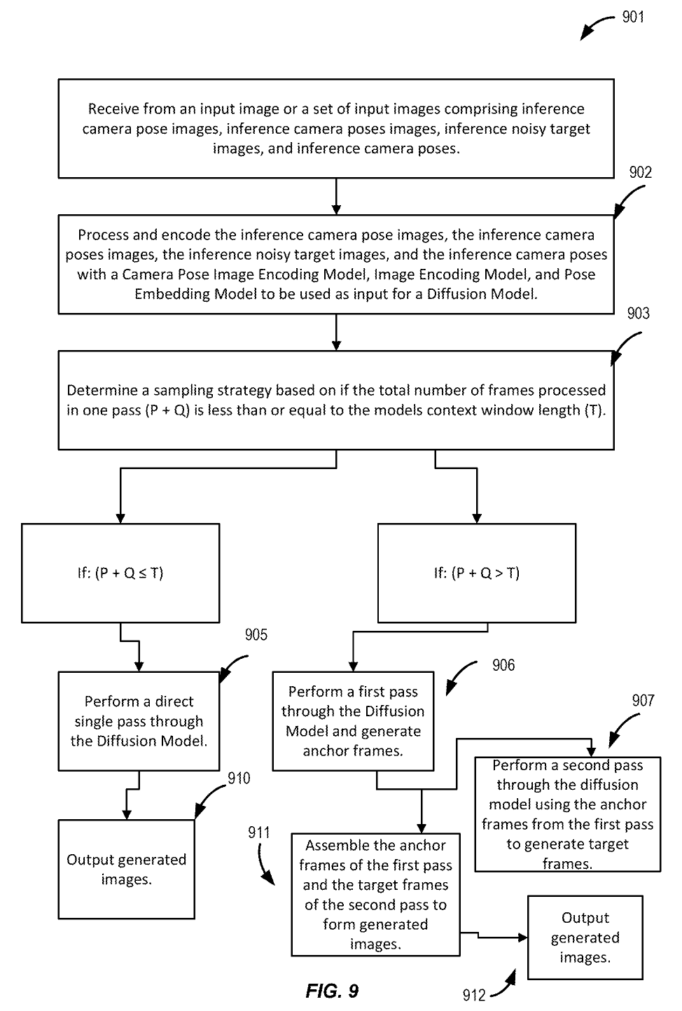

The processing performed using the inference system architecture described above with respect to FIG. 7 may be implemented using an inference time method. Examples of such a method is described below with respect to the method of FIG. 9.

The processing depicted in method 900 and any other FIGS. may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in method 900 , and other FIGS. described herein are intended to be illustrative and non-limiting. Although method 900, and other FIGS., depict the various processing steps occurring in a particular sequence or order, this is not intended to be limiting. In certain alternative embodiments, the processing may be performed in some different order or some steps may also be performed in parallel. It should be appreciated that in alternative embodiments the processing depicted in method 900, and other FIGS., may include a greater number or a lesser number of steps than those depicted in the respective figures.

FIG. 9 shows an example method 900 for 750, according to certain embodiments of the present disclosure. The method may be performed by the inference system 700 described above.

As illustrated in FIG. 9, an example method of inference 900 further comprises: at 901, receiving, from an input image or a set of input images comprising inference camera pose images, inference camera poses images, inference noisy target images, and inference camera poses; at 902, process and encode the inference camera pose images, inference camera poses images, inference noisy target images, and inference camera poses with a Camera Pose Image Encoding Model, Image Encoding Model, and a Pose Embedding Model to be provided as input to a Diffusion Model; at 903, determining a sampling strategy based on if the total number of frames process in one pass (P + Q) is less than or equal to the models context window length (t) from training; if (P + Q ≤ T), proceed to 905 and perform a direct single pass through the diffusion model and output the generated images at 910; if (P + Q > T), proceed to 906 and perform a first pass through the diffusion model and generate anchor frames; at 907, perform a second pass through the diffusion model using the anchor frames from the first pass to generate target frames; and, at 911, concatenate the anchor frames from the first pass and the target frames from the second pass to form the generated images and output the generated images at 912.

In various embodiments, the process of receiving and encoding the input images (901-902) may be implemented as follows. At 901, the image generation system 750 receives P user-provided images and Q user-specified target camera poses. At 902, the P input images are input to the Image Encoding Model 210 (e.g., VAE) to generate encoded images 718 latent representations, and to the Camera Pose Image Encoding Model 212 (e.g., CLIP) to create the cross attention 716. The camera poses for all P input images and Q target images are input to the Pose Embedding Model 214 to generate the pose embeddings 722. The input sequence 724 for the diffusion model 726 is generated by concatenating the P known image latents with Q tensors of pure, randomly generated Gaussian noise, with each latent or noise tensor being paired with its corresponding pose embedding.

The process of determining the sampling strategy (903) may be implemented by a control mechanism that compares the sum of the number of input images (P) and target images (Q) against the model’s fixed context window length, T (e.g., T = 21), wherein T is established during training. For example, if a user provides P=2 input images and requests a video with Q = 100 frames, the total P + Q = 102. The control module compares this value to T = 21 and, finding that 102 > 21, directs the system to execute the two-pass procedural sampling path and proceed to 906. Conversely, if the request was for Q=10 frames, making P+Q=12, the control mechanism would determine that 12 ≤ 21 and direct the image generation system 750 proceed to 905.

The process of performing the direct single pass (905) may be implemented when the entire generation task fits within the model's context window (e.g., P + Q ≤ 10). The input sequence 724, comprising P known latents and Q noise latents, is input to the diffusion model 726 which executes an iterative denoising process, progressively refining the Q noise latents into coherent images over a series of steps, conditioned by the P known latents. To enhance stability, the inference input sequence 724 may be padded to the full context length T by repeating the first input image. Upon completion of the denoising process, the final Q generated images are output at 910.

The process of generating anchor frames in the first pass (906) may be implemented to create a sparse but consistent set of keyframes for a long trajectory. For an ordered camera path (Trajectory NVS), this is achieved by first selecting a subset of the Q target camera poses using a uniform stride to ensure the anchor frames are evenly distributed. The diffusion model 726 is then conditioned on all P original input images and generates the novel views for only the sparse set of anchor poses. For an unordered set of target views (Set NVS), the anchor frames may be generated along a predefined trajectory prior, such as a 360-degree orbit around the object.

The process of generating target frames in the second pass (907) may be implemented as an interpolation process that fills in the gaps between the anchor frames. The image generation system 750 processes the trajectory segment by segment, wherein each segment is defined by two adjacent anchor frames generated at 906. For each segment, the diffusion model 726 is conditioned on the two bounding anchor frames. The image generation system 750 then synthesizes the intermediate frames for the camera poses within that segment.

The step of assembling the anchor frames from the first pass and the target frames of the second pass (911) may be implemented as a post-processing operation that is configured to retrieve the anchor frames generated at 906 and the target frames generated at 907 and arrange them in their correct temporal or spatial order according to the user-specified camera path to form and output the generated images at 912.

In an exemplary embodiment, the set of input images comprises two photographs (P=2) taken from different viewpoints of a scene or object and a camera path consisting of 100 target camera poses (Q=100). After processing and encoding the set of input images, the processors compute the total number of frames to be synthesized in a single pass as (P + Q) = 2 + 100 = 102. The processor is further configured to determine a sampling strategy based on a comparison between the total number of frames synthesized in the single pass and the model’s context window (t) from training. If the processor determines that the number of frames synthesized in the single pass is less than or equal to (P + Q ≤ T), the processor elects to perform a direct single pass through the diffusion model and output the generated images. If the processor determines that the number of frames synthesized in the single pass is greater than or equal to t (P + Q > T), the processor elects to perform a two-pass procedure. In said embodiment, where (P + Q) = 102 and t = 21, the processor can determine that 102 > 21 (the total number of frames synthesized in a single pass is greater than the context window) and elect to perform the procedural two pass procedure.

In certain embodiments where P + Q ≤ T, the two-pass procedure further comprises: performing a first pass through the diffusion model 726 to select anchor poses and generate anchor frames for each anchor pose; performing a second pass through the diffusion model 726 to generate the remaining target images by interpolating between the anchor frames generated in the first pass; assembling the anchor frames of the first pass and the target images of the second pass to form generated images 728; and, outputting the generated images 728.

In other embodiments where P + Q > T, the direct single pass further comprises performing one single pass through the diffusion model 726 and outputting the generated images 728 after the one single pass.

In similar embodiments, when performing a direct single pass where the total number of frames to be synthesized is less than the model's trained context window length (i.e., P + Q ≤ T), the image generation system 750 may employ a padding strategy to maintain stability and prevent color overflow artifacts. Rather than dynamically changing the context window T in a zero-shot manner, the system pads the forward pass so that it contains exactly T frames. In an exemplary embodiment, this padding is achieved by repeating the first input image (or its latent representation) until the sequence length equals T. The padding strategy may be configured to preserve global reference context and ensure that the diffusion model 726 operates within its optimal, trained tensor dimensions, thereby enhancing the overall fidelity of the generated images

In some embodiments where P + Q ≤ T, the set of input views may comprise an ordered set of views (e.g., a video sequence or a defined camera trajectory). For the ordered set of views, the first pass of the two-pass procedure executed by the diffusion model 726 may comprise employing an interpolation sampling strategy utilizing a uniform temporal or spatial stride to select anchor frames from a subset of the target camera poses. When employing the interpolation sampling strategy, the anchor frames are distributed to span the entirety of the camera path. For example, for a set of input images corresponding to 100 target camera poses, anchor frames may be selected at uniform indices, such as indices 0, 20, 40, 60, 80, and 99, resulting in six anchor frames. This uniform distribution ensures that the spatial or temporal “gaps” between adjacent anchor frames are of a consistent size, providing a structured framework for subsequent interpolation.

Upon completion of the first pass (906) for the ordered set of views, the image generation system 750 may be configured to perform a second pass (907) through the diffusion model 726 to generate the remaining target images. During the second pass (907), the image generation system 750 processes the camera path segment by segment, wherein each segment is defined by a pair of adjacent anchor frames. For each segment, the diffusion model 726 synthesizes intermediate frames by interpolating between the anchor frames to form a continuous video trajectory. Specifically, the diffusion model 726 is conditioned on the two anchor frames that bound the respective segment. The conditioning guides the diffusion model 726 to synthesize a sequence of intermediate frames that create a continuous and temporally smooth transition from the starting anchor frame to the ending anchor frame. By utilizing the bounding anchor frames as the primary conditioning context, the interpolation sampling strategy ensures temporal coherence and produces a fluid video output, effectively filling the gaps along the camera path.

In alternate embodiments where P + Q ≤ T, the set of input views may comprise an ordered set of views. For the ordered set of views, the image generation system 750 may be configured to employ a ground truth plus interpolation (gt + interp) sampling strategy. The gt + interp sampling strategy may be implemented by augmenting the conditioning utilized during both the first pass (906) and the second pass (907) of the two-pass procedure. During the first pass (906), when generating the anchor frames, the diffusion model 726 is conditioned on the complete set of original P input images (the ground truth) provided by the user to ensure the anchor frames are globally consistent with the source content. Subsequently, during the second pass (907), when generating the intermediate frames for a segment between two anchor frames, the diffusion model 726 is conditioned on both the two bounding anchor frames for that segment and the complete set of original P input images. The P input images are included in the input sequence 724, thereby providing the diffusion model 726 with a persistent, global reference to the original scene's appearance and geometry. Conditioning on the ground truth during both passes helps to significantly reduce drift and maintain high visual fidelity to the source content throughout the entire interpolation process.

In some embodiments where P + Q ≤ T, for an unordered set of views, the process of generating the two-pass procedure may be implemented using a nearest sampling strategy. During the first pass (906), the image generation system 750 may generate the K anchor frames by identifying and conditioning on the spatially nearest input images from the original P input images. For instance, for each selected anchor pose, the system may compute a distance metric (e.g., Euclidean distance) between the anchor pose and the poses of the original input images to identify the nearest input view(s). The diffusion model 726 may then synthesize the anchor frame conditioned on these nearest input views. Following the generation of the anchor frames in the first pass (906), the process of generating the remaining target frames (907) in the second pass is similarly implemented using the nearest sampling strategy. For each target camera pose that was not selected as an anchor, the system first identifies the single, spatially nearest anchor pose. This identification may be performed by computing the Euclidean distance between the feature vector (or spatial coordinates) of the target camera pose and the feature vectors (or spatial coordinates) of all K anchor poses. The image generation system 750 then groups all non-anchor target poses based on which anchor they are nearest to. The diffusion model 726 then proceeds to synthesize the novel images for each group, conditioned on the original P input images and the single, nearest anchor frame associated with that group. By conditioning each generated frame on its most spatially relevant counterpart, the nearest sampling strategy ensures that each generated view is locally consistent with its surroundings, thereby maintaining robust 3D spatial coherence across the entire unordered set of images

In alternate embodiments where P + Q ≤ T, for an unordered set of views, the image generation system 750 may be configured to employ a ground truth plus nearest (gt + nearest) sampling strategy. In such embodiments, the gt + nearest sampling strategy may be implemented by modifying the conditioning context used in the nearest sampling strategy described above. Specifically, during the first pass (906), the diffusion model 726 may be conditioned on the single spatially nearest original input image (selected from the P input images) corresponding to a given anchor pose, in combination with the complete set of original P input images (the ground truth) provided by the user. Subsequently, during the second pass (907), when synthesizing the novel images for a logically grouped set of non-anchor target poses, the diffusion model 726 is conditioned on the single nearest generated anchor frame for that group, alongside the complete set of original P input images. By conditioning the generation process on both the nearest available spatial reference frame and the complete set of P input images, the gt + nearest sampling strategy ensures that the synthesis of every view is consistently guided by both a locally relevant structural reference and the comprehensive global context of the original scene.

In some embodiments where P + Q ≤ T, when the number of target views Q is very large (e.g., for generating videos of 1000 frames or more), such that even the number of anchor frames to be generated in the first pass (906) exceeds the context window T, the image generation system 750 may implement a chunking strategy using a memory bank. The chunking strategy may be implemented by first dividing the set of anchor poses into smaller, sequential chunks that fit within the context window T. A first chunk is generated conditioned only on the original P input images. After each chunk is processed, the generated anchor frames and their associated poses are stored in the memory bank. When processing each subsequent chunk, the diffusion model 726 is conditioned on the original input images and on a selection of previously generated anchor frames retrieved from the memory bank. Crucially, the system retrieves the anchor frames from the memory bank that are spatially nearest to the anchor frames in the current chunk, rather than temporally nearest. The spatial lookup ensures long-range 3D consistency, mitigating drift and artifacts, especially for complex or looping camera trajectories where a viewpoint may be revisited after a long temporal gap.

In similar embodiments, a chunking strategy may also be implemented during the second pass (907) if the number of intermediate frames to be generated within a single segment between two anchors is too large for the context window T. This is implemented by dividing the intermediate frames of the long segment into smaller, sequential chunks. A first chunk is generated conditioned on the original input images and the two anchor frames that bound the segment. For each subsequent chunk within the same segment, the diffusion model 726 is conditioned on the two bounding anchor frames, the original input images, and the most recently generated intermediate frames from the immediately preceding chunk. This creates a localized, auto-regressive rollout that ensures a smooth transition across the sub-chunks, effectively bridging the gap between the two distant anchor frames.

In further embodiments, for a semi-dense view regime (e.g., where the number of input views P ≥ 9), the image generation system 750 may be configured with zero-shot generalization capabilities regarding the context window length T. While the diffusion model 726 may be explicitly trained using a fixed context window (e.g., T = 21), the architecture of the diffusion model 726 enables the image generation system 750 to dynamically scale to larger T values during inference without requiring any additional fine-tuning or retraining.

In addition to zero-shot generalization regarding T, the image generation system 750 may be further configured to exhibit zero-shot generalization with respect to image resolution. In various embodiments, the diffusion model 726 is trained exclusively on square images having a fixed spatial resolution (e.g., H = W = 576 pixels). However, during inference, the diffusion model 726 can seamlessly process and synthesize images of arbitrary resolutions and aspect ratios (e.g., 1024x768 landscape, or 1080x1920 portrait) without architectural modifications or retraining.

In exemplary embodiments, the outputs of the first pass and second pass are assembled or otherwise aggregated to form generated images 728. Specifically, the generated images 728 comprise both: (i) the anchor frames generated at the selected anchor poses during the first pass (906), and (ii) the target images generated during the second pass (907), wherein the second pass is performed by conditioning the diffusion model on the anchor frames from the first pass.

In some embodiments where P + Q ≤ T or P + Q > T, the diffusion model 726 may be configured with an optional temporal pathway that can be selectively enabled or disabled during inference based on the nature of the input views. The optional temporal pathway incorporates the 3D Convolution Layer 804 of the plurality of layers in the U-net of the diffusion model 726 to leverage temporal redundancy and improve the smoothness of the generated images 728.

Upon receiving an indication that the set of input images is an ordered set (e.g., consecutive frames from a video sequence), the optional temporal pathway is enabled. In said embodiments, the data proceeds along a longer data flow path comprising the 2D Convolution Layer 802, the 3D Convolution Layer 804, the 2D/3D Attention Layer 806, and the 1D Attention Layer 808. By routing data through the 3D Convolution Layer 804, the diffusion model 726 applies spatio-temporal filters across the ordered frames to capture local motion and ensure temporally smooth transitions between the generated images 728.

Conversely, upon receiving an indication that the set of input images is an unordered set (e.g., a casual collection of images with no temporal sequence), the optional temporal pathway is disabled. In said embodiments, the data flow bypasses the 3D Convolution Layer 804 and proceeds along a shortened data flow path comprising the 2D Convolution Layer 802, the 2D/3D Attention Layer 806, and the 1D Attention Layer 808. Because the unordered images lack a sequential relationship, disabling the 3D Convolution Layer 804 prevents the model from attempting to extract non-existent temporal features, thereby maintaining inference efficiency and generation quality for set-based novel view synthesis.

During a pass through the diffusion model 726, the data is progressively altered at each layer of the U-Net architecture to synthesize the novel views. Initially, the 2D convolution layer 802 receives the inference input sequence 724 and the inference pose embeddings 722. The 2D convolution layer 802 operates on each frame independently, altering the data by extracting intra-frame spatial features (e.g., edges, shapes, and textures) while simultaneously conditioning the extracted features. If the temporal pathway is enabled, the resulting feature map from the 2D convolution layer 802 is passed to the 3D convolution layer 804. The 3D convolution layer 804 alters the data by applying spatio-temporal filters across the view dimension, capturing local motion and short-range inter-frame relationships to enforce smooth transitions between consecutive frames. The altered feature maps from the 2D and 3D convolution layers are then combined and provided to the 2D/3D attention layer 806. The 2D/3D attention layer 806 alters the combined data by establishing long-range spatial and multi-view consistency; it computes attention scores that allow each pixel location in the feature map to attend to other locations across the entire sequence of views. This layer is further modulated by the inference cross attention 716 to inject high-level semantic information (e.g., global image features derived from the CLIP model) into the feature map. Finally, the data is processed by the 1D attention layer 808, which performs attention operations strictly along the view axis. The 1D attention layer 808 alters the feature map by efficiently refining the geometric relationships between the different camera poses without excessive computational overhead. The outputs from the 2D/3D attention layer 806 and the 1D attention layer 808 are subsequently combined via skip connections to form a final denoised feature map, which the diffusion model 726 utilizes to output the generated images 728.

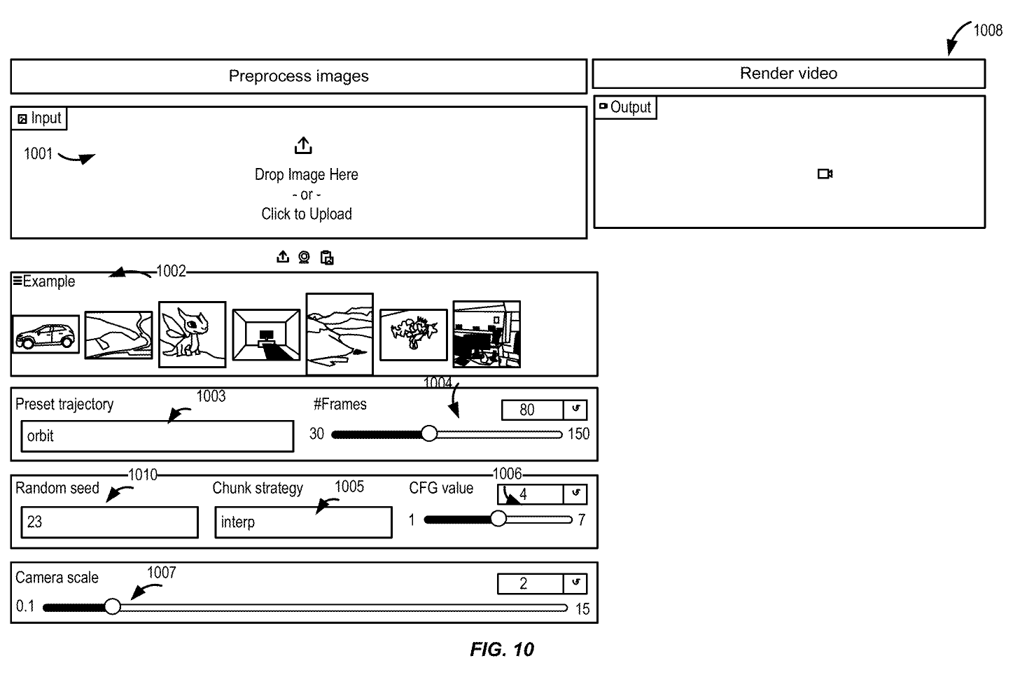

The inference method 900 may further be configured to form the generated images 728 based on an indication of a request from a user interface 1000 as shown in FIG. 10.

FIG. 10 shows an example implementation of the user interface 1000, according to certain embodiments of the present disclosure. The user interface includes configurable components for adjusting generation parameters comprising, image input 1001, example image input 1002, preset trajectory 1003, number of frames 1004, random seed value 1010, chunk strategy 1005, CFG (Classifier-Free Guidance) value 1006, camera scale 1007. Upon completion of user configuration, an output panel 1008 presents the results to the user.

The image input component 1001 can be configured to receive an image that represents an observed view that is used to generate a novel view. In an exemplary embodiment, the image input component comprises an interactive area (e.g., “dropzone”) where a user may click within the interactive area to open a standard file selection dialog, from which they can navigate their local storage and select one or a plurality of image files; or wherein a user can select one or more image files from their file explorer and drag them directly onto the designated area to initiate the upload (e.g., “drag and drop” ). In further embodiments, the image input component may be configured to accept a variety of standardized image formats and layouts, including but not limited to PNG, JPEG/JPG, TIFF, BMP, Portrait, Landscape, and others.

The example image input component 1002 can be configured to provide a preview of the image uploaded to image input component and enable the user to confirm the correct input image or plurality of input images and associated viewpoints prior to generation. In an exemplary embodiment, this component may be a visual display pane or thumbnail viewer.

The preset trajectory component 1003 can be configured to enable a user to select a predefined camera path from a set of predefined camera paths that determines the sequence of virtual camera poses for the target views. In an exemplary embodiment, this component may be a dropdown menu offering a variety of predefined camera paths comprising common cinematic and exploratory camera movements.

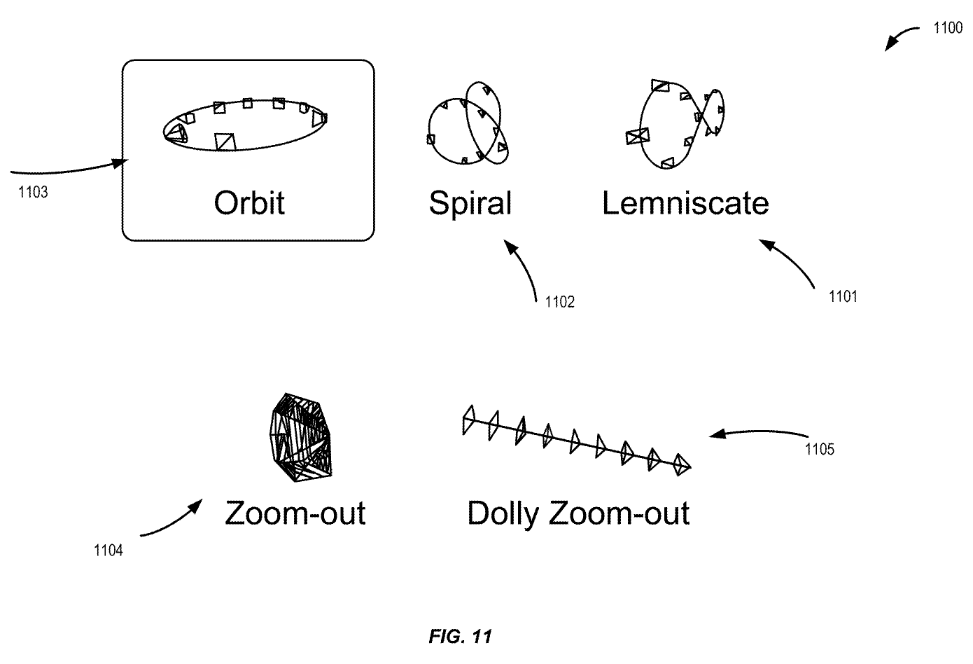

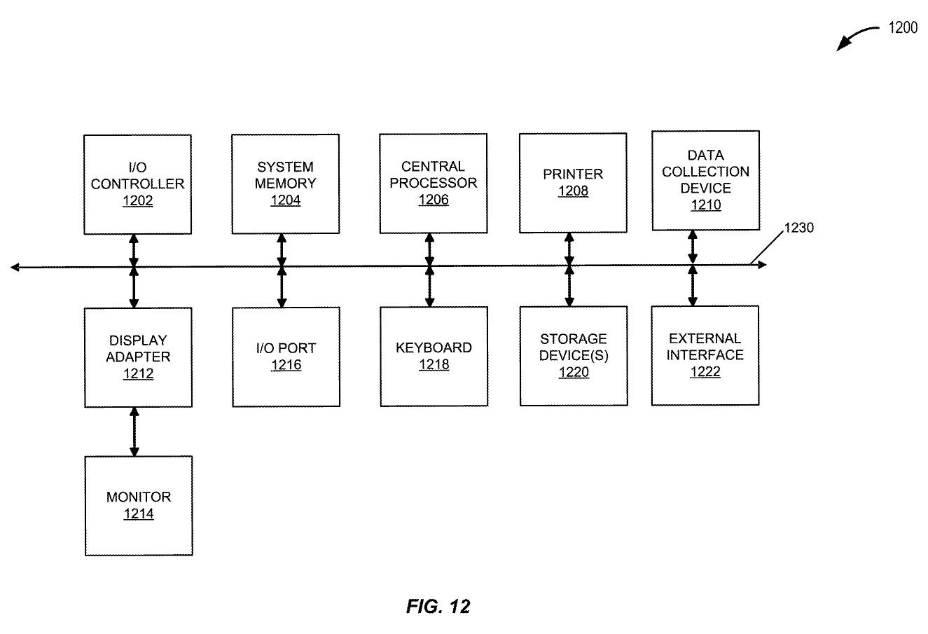

In exemplary embodiments, and as illustrated in FIG. 11, the set of predefined camera paths 1100 may comprise lemniscate 1101, spiral 1102, orbit 1103, Zoom-out 1104, Dolly Zoom-out 1105.

The number of frames component 1004 can be configured to enable the user to specify the total number of target frames to be generated along the selected camera path. In an exemplary embodiment, this component may be a numerical slider enabling the user to select an integer value representing the number of frames within a predefined range (e.g., from 1 to 150) and configured such that if a user moves the slider to the left it decreases the number of frames, while a move to the right increases the number of frames. A greater number of frames results in a denser sampling of the camera trajectory, producing a more fluid and continuous animation. A lesser number of frames results in a sparser sampling of the camera trajectory, producing a less fluid animation that appears more like a sequence of distinct keyframes, but requires less computing power and produces faster output. This component is technically significant as the specified number of frames (Q), in conjunction with the number of input frames (P), determines the inference strategy. If the total P + Q is within the model's training context window (e.g., T=21), a one-pass generation is used. If P + Q exceeds this limit, the system automatically engages a two-pass procedural sampling strategy to ensure long-range temporal and 3D consistency, first generating sparse anchor frames and then interpolating between them.

The random seed value component 1010 can be configured to enable the user to select an integer value that serves as the initial state for a pseudorandom number generator used during generation. In an exemplary embodiment, this component is a numerical input field configured to accept an integer value input by the user. In some embodiments, if the user wanted to ensure reproducibility, they would keep the seed value the same across multiple generation attempts. By fixing the seed, the system treats the generation process as deterministic; for a given set of all other inputs and parameters, the model will produce the exact same pixel-for-pixel output every time. This allows the user to isolate variables and precisely observe the effect of changing another parameter. Conversely, when a user wishes to explore generative diversity, they would intentionally change the seed value between generation runs. The system treats each unique integer seed as a different starting point, leading to a different but equally plausible outcome. By changing the seed, the user directs the model to generate a distinct interpretation of any uncertain or unseen regions of the scene, enabling the exploration of multiple creative variations from a single input.

The chunk strategy component 1005 can be configured to enable the user to select how large sets or long trajectories are generated across one or more passes. In an exemplary embodiment, this component may be a drop down menu enabling the user to select from a variety of chunk strategies comprising, without limitation, an interpolation (interp) sampling strategy, which is optimized for creating temporally smooth video trajectories by generating intermediate frames between sparsely-sampled anchor frames; a nearest sampling strategy, which is suited for generating unordered image sets by conditioning each target view on its spatially nearest anchor frame; enhanced variations such as ground-truth plus nearest sampling strategy (gt + nearest) and ground-truth plus interpolation sampling strategy (gt + interp), which append the original input images to each generation chunk for improved consistency; and a one-pass strategy for more direct, sequential generation.

The CFG value component 1006 can be configured to enable a user to select the specific sampling methodology which the system will employ when generating novel views. In an exemplary embodiment, the CFG value component may be a numerical slider enabling the user to select an integer value representing the CFG value within a predefined range (e.g., from 1 to 7) and configured such that if a user moves the slider to the left it decreases the CFG value, while a move to the right increases the CFG value. The guidance scale is used to determine between generative diversity (the model’s capacity to produce varied and creative outputs) and fidelity (the models adherence to the provided inputs and conditioning information).

A higher CFG value indicates increased fidelity and enforces stronger adherence to the input images and camera poses. This constrains the model to generate outputs that are consistent with the input images and camera poses and results in sharp, deterministic, and photorealistic novel views. This is preferable in scenarios with high generation uncertainty, such as instances where only one input image is provided and the model must infer unseen regions (e.g., the back of an object).

Conversely, a lower CFG value indicates increased generative diversity and reduces adherence to the input images and camera poses, allowing the model's unconditional, learned prior to have more influence. This results in greater diversity and randomness in generated novel view outputs. The model has more freedom to synthesize plausible variations in texture and detail that are consistent with, but not strictly determined by, the input. This is ideal for scenarios with low generation uncertainty, such as multi-view synthesis where several input images already constrain the scene geometry and appearance significantly. With multiple views, the model's task shifts from large-scale generation to primarily interpolation.

The camera scale component 1007 can be configured to enable the user to adjust the unit-length or scene scale normalization applied to camera parameters to mitigate single-view scale ambiguity. In an exemplary embodiment, the camera scale component may be a numerical slider enabling the user to select an integer value representing the camera scale within a predefined range (e.g., from 0.1 to 15) and configured such that if a user moves the slider to the left it decreases the camera scale, while a move to the right increases the camera scale. A lower camera scale value results in camera movements of a smaller magnitude, which is proportionally appropriate for generating novel views of large, expansive scenes such as landscapes or architectural interiors. Conversely, a higher camera scale value results in camera movements of a larger magnitude, which is better suited for contained, object-centric scenes where more significant camera motion is required to reveal the object’s three-dimensional form.

The output panel component 1008 can be configured to present the final synthesized video or sequence of novel views to the user, based on the input provided by the user, following generation. In exemplary embodiments, the output panel component may be a media player or video display panel configured with standard playback controls, including, without limitation, a play/pause button, a timeline scrubber, frame-by-frame navigation, playback speed adjustment, content looping, and a full screen display mode. In further embodiments, the output panel component may comprise relevant metadata about the generated asset, such as the final resolution, frame count, and the time taken for generation. In other embodiments, the output panel component may include an export or download function, enabling the user to save the synthesized video to their local storage in a standard media format (e.g., MP4).

In some embodiments, the user can upload multiple images and interact with an advanced interface. The advanced interface can be configured to enable the user to set a camera trajectory by interacting with a 3D viewport.

Any of the computer systems mentioned herein may utilize any suitable number of subsystems. Examples of such subsystems are shown in FIG. 12 in computer system 1200. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones and other mobile devices.

The subsystems shown in FIG. 12 are interconnected via a system bus 1230. Additional subsystems such as a printer 1208, keyboard 1218, storage device(s) 1220, monitor 1214 (e.g., a display screen, such as an LED), which is coupled to display adapter 1212, and others are shown. Peripherals and input/output (I/O) devices, which couple to I/O controller 1202, can be connected to the computer system by any number of means known in the art such as input/output (I/O) port 1216 (e.g., USB, FireWire^{®}). For example, I/O port 1216 or external interface 1222 (e.g., Ethernet, Wi-Fi, etc.) can be used to connect computer system 1200 to a wide area network such as the Internet, a mouse input device, or a scanner. The interconnection via system bus 1230 allows the central processor 1206 to communicate with each subsystem and to control the execution of a plurality of instructions from system memory 1204 or the storage device(s) 1220 (e.g., a fixed disk, such as a hard drive, or optical disk), as well as the exchange of information between subsystems. The system memory 1204 and/or the storage device(s) 1220 may embody a computer readable medium. Another subsystem is a data collection device 1210, such as a camera, microphone, accelerometer, and the like. Any of the data mentioned herein can be output from one component to another component and can be output to the user.

A computer system can include a plurality of the same components or subsystems, e.g., connected together by external interface 1222, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components. In various embodiments, methods may involve various numbers of clients and/or servers, including at least 10, 20, 50, 100, 200, 500, 1,000, or 10,000 devices. Methods can include various numbers of communication messages between devices, including at least 100, 200, 500, 1,000, 10,000, 50,000, 100,000, 500,00, or one million communication messages. Such communications can involve at least 1 MB, 10 MB, 100 MB, 1 GB, 10 GB, or 100 GB of data.

Aspects of embodiments can be implemented in the form of control logic using hardware circuitry (e.g., an application specific integrated circuit or field programmable gate array) and/or using computer software stored in a memory with a generally programmable processor in a modular or integrated manner, and thus a processor can include memory storing software instructions that configure hardware circuitry, as well as an FPGA with configuration instructions or an ASIC. As used herein, a processor can include a single-core processor, multi-core processor on a same integrated chip, or multiple processing units on a single circuit board or networked, as well as dedicated hardware. The computations can be performed in parallel by the different processing units and/or different processing threads of a single processing unit. Based on the disclosure and teachings provided herein, a person of ordinary skill in the art will know and appreciate other ways and/or methods to implement embodiments of the present disclosure using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such devices. In addition, the order of operations may be re-arranged. A process can be terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Any operations performed with a processor may be performed in real-time. The term “real-time” may refer to computing operations or processes that are completed within a certain time constraint. As examples, a time constraint may be 30 seconds, 1 minute, 10 minutes, 30 minutes, 1 hour, 4 hours, 1 day, or 7 days. Thus, embodiments can be directed to computer systems configured to perform the steps of any of the methods described herein, potentially with different components performing a respective step or a respective group of steps. Although presented as numbered steps, steps of methods herein can be performed at a same time or at different times or in a different order. Additionally, portions of these steps may be used with portions of other steps from other methods. Also, all or portions of a step may be optional. Additionally, any of the steps of any of the methods can be performed with modules, units, circuits, or other means of a system for performing these steps.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of "a", "an" or "the" is intended to mean "one or more" unless specifically indicated to the contrary. The use of “or” is intended to mean an “inclusive or,” and not an “exclusive or” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

All patents, patent applications, publications, and descriptions mentioned herein are incorporated by reference in their entirety for all purposes. None is admitted as prior art. Where a conflict exists between the instant application and a reference provided herein, the instant application shall dominate.

What is claimed is:

1. An image generation system comprising:
one or more storage media storing instructions; and
one or more processors configured to execute the instructions to cause the image generation system to:
receive an input image that depicts an object from a first virtual camera pose and an indication of a set of virtual camera poses;
generate, by using the input image and the set of virtual camera poses as input to one or more encoding models, an image embedding and a virtual camera pose embedding; and
generate, by using the image embedding and the virtual camera pose embedding as input to one or more diffusional models, a first set of images depicting the object from the set of virtual camera poses.

2. The image generation system of claim 1, wherein the indication of the set of virtual camera poses includes a camera path shape formed by the set of virtual camera poses.

3. The image generation system of claim 2, wherein executing the instructions further causes the image generation system to:
receive, an indication of a number of images to be included in the first set of images.

4. The image generation system of claim 1, wherein the indication of the set of virtual camera poses includes a set of virtual camera positions.

5. The image generation system of claim 1, wherein a virtual camera pose included in the set of virtual camera poses includes a position of a camera and an angle of the camera.

6. The image generation system of claim 1, wherein a virtual camera pose included in the set of virtual camera poses includes an x-axis position, a y-axis position, a z-axis position, a pitch, a yaw, and a roll of the virtual camera.

7. The image generation system of claim 1, wherein executing the instructions further causes the image generation system to:
receive an indication of a number of images to be generated that depict the object from the set of virtual camera poses.

8. The image generation system of claim 1, wherein executing the instructions further causes the image generation system to:
receive a plurality of input images that depict the object from a plurality of virtual camera poses, wherein the plurality of input images includes the input image and wherein the plurality of virtual camera poses includes the first virtual camera pose.

9. A method for generating an image comprising:
receiving an input image that depicts an object from a first virtual camera pose and an indication of a set of virtual camera poses;
generating a virtual camera pose embedding based at least in part on a virtual camera pose of the set of virtual camera poses;
generating an image embedding based on the input image; and
generating, based at least in part on the image embedding and the virtual camera pose embedding, a first set of images depicting the object from the set of virtual camera poses.

10. The method of claim 9, further comprising:
receiving a second virtual camera pose included in the set of virtual camera poses,
generating a virtual camera pose embedding based at least in part on the second virtual camera pose;
generating a first noisy embedding;
generating a second embedding based at least in part on the input image; and
generating an embedding of an output image included in the first set of images based at least in part on the virtual camera pose embedding, the first noisy embedding, and the second embedding.

11. The method of claim 9, further comprising:
generating, by using the input image as input to a camera pose image encoding model, a cross attention encoding; and
generating, by using the cross attention encoding as input to a diffusion model and based at least in part on the set of virtual camera poses, the first set of images.

12. The method for generating an image of claim 9, further comprising:
generating, by using the input image as input to an image encoding model, a first encoded image;
generating a noisy latent image; and
generating, by using the first encoded image and the noisy latent image as input to a diffusion model, the first set of images.

13. The method of claim 9, further comprising:
including, within the first set of images, an image depicting the object from a virtual camera position different from the first virtual camera pose and generated from a noisy latent image.

14. A non-transitory computer readable medium storing instructions that, when executed by one or more processors, cause the one or more processors to perform operations comprising:
receiving an input image that depicts an object from a first virtual camera pose and an indication of a set of virtual camera poses;
generating a virtual camera pose embedding based at least in part on a virtual camera pose of the set of virtual camera poses;
generating an image embedding based on the input image; and
generating, based at least in part on the image embedding and the virtual camera pose embedding, a first set of images depicting the object from the set of virtual camera poses.

15. The non-transitory computer readable medium of claim 14, wherein the instructions, when executed by one or more processors, further cause the one or more processors to perform additional operations comprising:
generating the first set of images based at least on the input image and the set of virtual camera poses as input for a diffusion model;
generating, from the first set of images as conditioning for the diffusion model, a second set of images depicting the object from a subset of the set of virtual camera poses; and
generating a third set of images by combining the first set of images and the second set of images.

16. The non-transitory computer readable medium of claim 14, wherein the instructions, when executed by one or more processors, further cause the one or more processors to perform additional operations comprising:
determine, based at least in part on a number P of input images and a number Q of target virtual camera poses in the set of virtual camera poses, that a sum (P + Q) is less than or equal to a context window length T associated with training of a diffusion model that outputs the first set of images;
based at least in part on the sum (P + Q) being less than or equal to the context window length T, generate the first set of images in a single pass of the diffusion model.

17. The non-transitory computer readable medium of claim 14, wherein the instructions, when executed by one or more processors, further cause the one or more processors to perform additional operations comprising:
determining, based at least in part on a number P of input images and a number Q of target virtual camera poses in the set of virtual camera poses, that a sum (P + Q) is less than or equal to a context window length T associated with training of a diffusion model that outputs the first set of images;
based at least in part on the sum (P + Q) being greater than the context window length T, performing a first pass of the diffusion model to generate, based at least in part on the input image and a subset of the set of virtual camera poses, a plurality of anchor images depicting the object from corresponding anchor virtual camera poses; and
performing a second pass of the diffusion model to generate, based at least in part on the anchor images and at least a portion of the input image, additional images depicting the object from remaining virtual camera poses of the set of virtual camera poses, and to combine the anchor images and the additional images to form the first set of images.

18. The non-transitory computer readable medium of claim 14, wherein the instructions, when executed by one or more processors, further cause the one or more processors to perform additional operations comprising:
generating, by using the input image as input to a camera pose image encoding model, a cross attention encoding; and
generating, by using the cross attention encoding as input to the diffusion model and based at least in part on the set of virtual camera poses, the first set of images.

19. The non-transitory computer readable medium of claim 14, wherein the instructions, when executed by one or more processors, further cause the one or more processors to perform additional operations comprising:
generating, by using the input image as input to an image encoding model, a first encoded image;
generating a noisy latent image; and
generating, by using the first encoded image and the noisy latent image as input to the diffusion model, the first set of images.

20. The non-transitory computer readable medium of claim 14, wherein the instructions, when executed by one or more processors, further cause the one or more processors to perform additional operations comprising:
including the first set of images that comprises an image depicting the object from a virtual camera position different from the first virtual camera pose and generated from the noisy latent image.
